(19) United States
(12) Patent Application Publication
(10) Pub. No.: US 2012/0254055 A1
(43) Pub. Date: Oct. 4, 2012

(54) METHOD AND SYSTEM FOR VERIFICATION AND ACCEPTANCE OF AN ELECTRONIC CONTRACT

(76) Inventors: Derek BULLEN, Calgary (CA); Ramasamy CHANDRASEKERAN, Calgary (CA); Maya CHARLES, Calgary (CA); Gary SCHULTZ, Calgary (CA); Vinod PURUSHOTHAMAN, Kerala (IN); Loshy Pathiyil CHANDRAN, Kerala (IN); Suresh KAYAPPURATH, Kerala (IN); Gnanmuthu GUNASUNDARAM, Tamilnadu (IN)

(21) Appl. No.: 13/432,627

(22) Filed: Mar. 28, 2012

(30) Foreign Application Priority Data
Mar. 28, 2011 (CA) 2735501

(51) Int. Cl. G06Q 10/06

(52) U.S. Cl. 705/321

(57) ABSTRACT

A system and method for verification and/or acceptance of an electronic employment contract. According to an embodiment, a notification is sent or otherwise transmitted to a candidate, and the notification includes a link for accessing a landing or web page. The page is configured to authenticate the candidate's credentialed and once logged on, the candidate is presented with a page that is configured to allow the candidate to review and/or verify the employment contract presented in an electronic form or rendering. The page is also configured with a confirmation control thereby allowing the candidate to confirm acceptance of the employment contract in its electronic form. The acceptance by the candidate is confirmed to the candidate and the electronic employment contract as accepted is archived and the acceptance parameters are logged.

### FIELD OF THE INVENTION

The present invention relates to computer systems, and more particularly, to a computer-implemented method and system for verification and acceptance of an electronic contract or e-contract, such as an employment contract or a consulting contract.

### BACKGROUND OF THE INVENTION

Technological developments continue to reshape how individuals communicate and work. Traditional physical offices and workplace infrastructure have been replaced with virtual offices. Technological developments have created a workforce with greater mobility.

While the way people work has changed, the terms of employment and engagement typically comprise paper-based contracts. Paper-based contracts require obtaining physical signatures, which can be time-consuming, for example both for the initial new contract and subsequent contract renewals. In addition, the use of paper-based contracts is not easily scalable, and an employee agency (e.g. account executives) will spend considerable resources and time chasing paper contracts, which increases the sales cycle and reduces the number of hours available for selling and account management.

Further disadvantages or shortcomings with paper-based contracts include the need for candidates (e.g. employees or consultants) to have access to a scanner in order to submit their signed contracts. The tracking, storage and archiving of both hard and electronic copies of paper-based contracts. The verification or review of submitted scanned copies.

Accordingly, there remains a need for improvement in the art of contracting for services or employment.

### BRIEF SUMMARY OF THE INVENTION

The present invention is directed to embodiments of a method and system for acceptance and/or verification of an electronic contract for employment or consulting or other contracted services.

According to an embodiment, the present invention provides a system for acceptance and verification of an employment contract created online.

According to another embodiment, the present invention provides a system for verifying an electronic contract accepted by a consultant.

According to another embodiment, the present invention provides a method for generating and verifying an electronic contract for employment.

According to one aspect or embodiment, the present invention comprises a method for generating and verifying an electronic contract for employment by an employee, said method comprising the steps of: transmitting a notification to the employee, said notification including a link to access a graphical user interface based login page; confirming credentials inputted by the employee at said login page; presenting the employee with a graphical user interface based page including an electronic copy of the employment contract; receiving a confirmation input from the employee at said graphical user interface page; in response to said confirmation input storing a copy of said electronic copy of the employment contract; and in response to said confirmation input issuing a notification of acceptance of the employment contract.

According to another aspect or embodiment, the present invention comprises a system for confirming acceptance of an employment contract by an employee, said system comprising: a server operatively coupled to one or more computers associated with one or more users; a component configured for transmitting a notification to the computer associated with the employee; said notification being configured with a link, and said server being responsive to actuation of said link by the employee for downloading a login page to the computer associated with the employee; said login page being configured to initiate a login procedure requiring one or more credentials for authenticating the employee; in response to an authenticated login, said server having a component configured for downloading a review contract page to the computer associated with the employee, said review contract page being configured with a window responsive to the employee for viewing an electronic copy of the employment contract, and said review contract page including an acceptance control responsive to an input from the employee; said server having a component configured for receiving confirmation of acceptance of the employment contract by the employee and generating a notification of acceptance.

According to another aspect or embodiment, the present invention comprises a computer program product for performing an acceptance procedure for an electronic employment contract, said computer program product comprising: a storage medium for storing computer executable instructions, said instructions comprising, generating a graphical user interface page configured for a browser, said page including a scrollable window for displaying said employment contract in an electronic form or rendering and an acceptance control responsive to an input from an employee; generating a contract acceptance state; storing a copy of said electronic contract and logging said contract acceptance state.

Other aspects and features according to the present application will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example, embodiments according to the present invention, and in which:

FIG. 1 shows in block diagram form a system for generating and verifying an electronic contract according to an embodiment of the present invention;

FIG. 2 shows in flowchart form a method or process for accepting and verifying an electronic contract according to an embodiment of the present invention;

FIG. 3 is a screen shot of a page or window configured to send an electronic contract to an employment candidate according to an embodiment of the present invention;

FIG. 4 is a screen shot of a page or window or graphical user interface screen configured for composing an email and reviewing an E-Contract according to an embodiment of the present invention;

FIG. 5 a screen shot of a page or window or graphical user interface screen configured for reviewing the notification or email to be sent to a candidate for the verification process according to an embodiment of the present invention;

FIG. 6 is a screen shot of a page or window or graphical user interface screen configured to display the form of a typical E-Contract, according to an embodiment of the present invention;

FIG. 7 is a screen shot of a “Review Summary of Terms” page generated according to an embodiment of the present invention;

FIG. 8 is a screen shot of a “Review E-Contract” page or window according to an embodiment of the invention;

FIG. 9 is a screen shot of a pages or window configured for a candidate to confirm acceptance of an E-Contract according to an embodiment of the present invention;

FIG. 10 is a screen shot of an “Acceptance Acknowledgement” page or window generated according to an embodiment of the present invention;

FIG. 11 is a screen shot of a page or window configured for a candidate to confirm declination or refusal of an E-Contract according to an embodiment of the present invention; and

FIG. 12 is a screen shot of a “Declination Acknowledgement” page or window generated according to an embodiment of the present invention.

Like reference numerals indicate like or corresponding elements in the drawings.

### DETAILED DESCRIPTION OF THE EMBODIMENTS

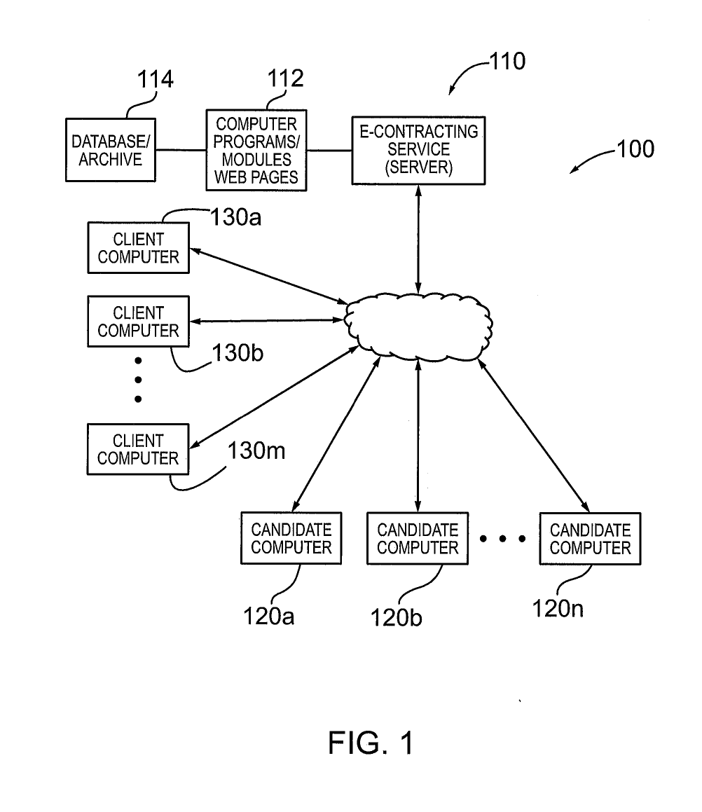

Reference is first made to FIG. 1, which shows in block diagram form a system for accepting and/or verifying an electronic contract (i.e. E-Contract) according to an embodiment of the present invention. The system is indicated generally by reference 100 and comprises an E-contracting system or module 110. According to an embodiment, the E-Contracting system 110 comprises a Web server and is configured to communicate with a plurality of candidate computers 120, indicated individually by references 120a, 120b . . . 120n, and with one or more client computers 130, indicated individually by references 130a, 130b . . . 130m. In the context of the present description, a candidate computer 120 corresponds to a computer or other type of processing or communication device (e.g. personal computer, mobile phone, table, netbook, etc.) associated with a candidate (e.g. a potential employee, consultant, existing employee or consultant). Similarly, a client computer 130 corresponds to a computer or other type of processing or communication device (e.g. personal computer, mobile phone, table, netbook, etc.) associated with a client (e.g. a potential employer or an existing employer). The server 110 is operatively coupled to a program module 112 and a database 114. The program module 112 may comprise a separate module or a logical module configured to run/store the programs, applications, webpages, graphical user interfaces, and any other executable or static components associated with the server 110 and the system 100 as described herein. The database 114 comprises a mass storage or memory device and is configured to store candidate data, contracts, client data, logged data, archived data and other information or data associated with the system 100. The particular implementation details will be within the understanding of one skilled in the art.

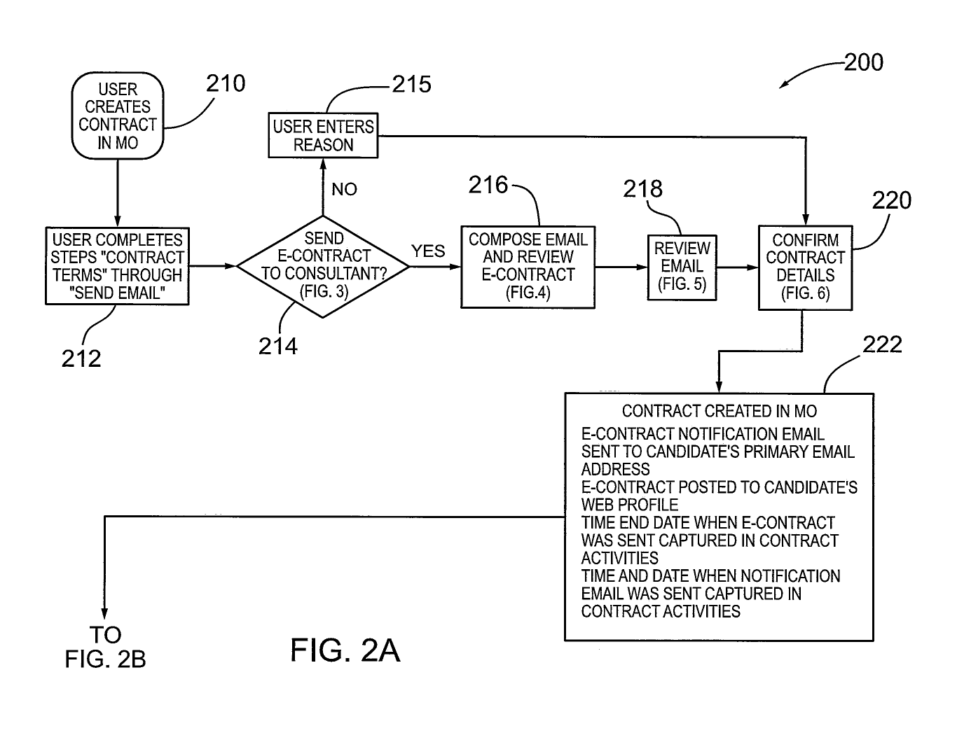

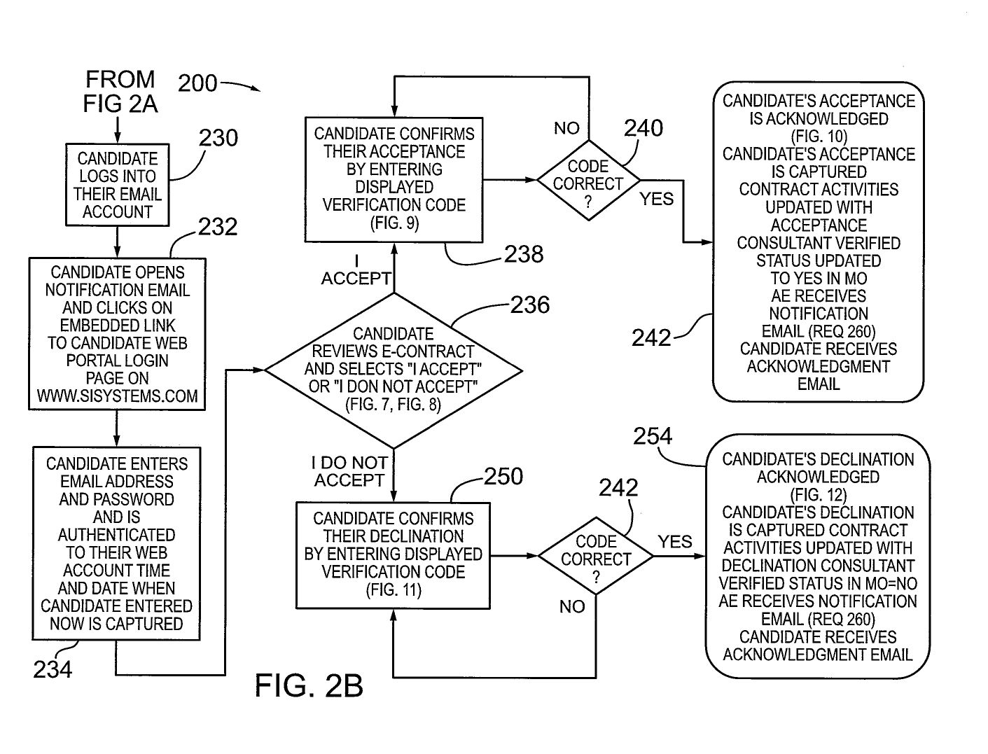

Reference is next made to FIG. 2, which shows an exemplary implementation of a verification and/or acceptance process according to an embodiment of the present invention and indicated generally by reference 200. The exemplary process comprises modules and functional elements or components comprising both hardware or system elements (e.g. computers, servers, data storage, personal or portable computing devices) and software elements or applications (e.g. computer programs, communication software, database management software or applications). It will be appreciated that the functionality and features associated with the system according to the exemplary implementation and other embodiments described herein may be implemented using executable computer software or code in the form of code objects, functional modules, components, libraries, hardware and any combinations thereof. The particular implementation details will be within the understanding of those skilled in the art.

As shown in FIG. 2, an E-Contract is created by a user using the system 110 (FIG. 1) as indicated by reference 210. The system 110 can comprise a module or application for creating employee or consultant E-Contracts indicated generally by reference 112 (FIG. 1), for example, the MatchGuide™ system from S.i. Systems. According to this aspect, the contract is created and saved or stored in a database or other mass storage or memory as indicated generally by reference 114 (FIG. 1.). In the context of the present description, the term “user” refers to an individual or entity that has privileges and/or resources for creating an E-Contract. For instance, the user can be associated with the E-Contracting system or entity 110, for example, an Account Executive, or the user can be associated with one of the clients 130, for example, an outsourcing administrator at a client company or organization. Once the user has created the E-Contract, the system 110 is configured to present the user with a “Send Email” prompt as indicated by reference 212 in FIG. 2. In response, the system 110 is configured to display a “Send E-Contract” page or window as indicated by reference 214.

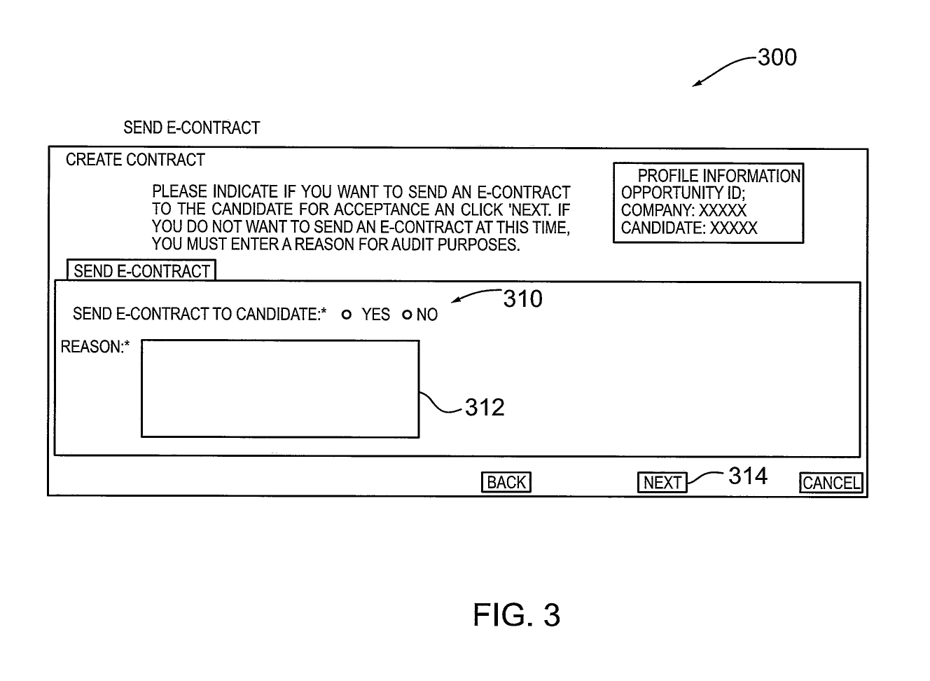

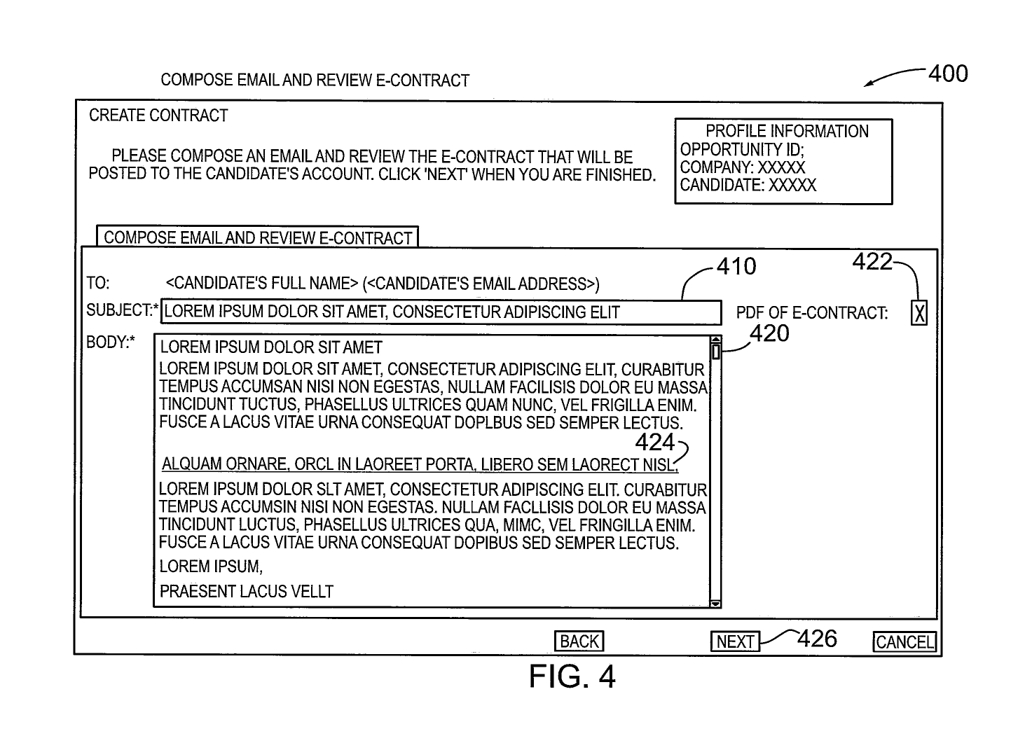

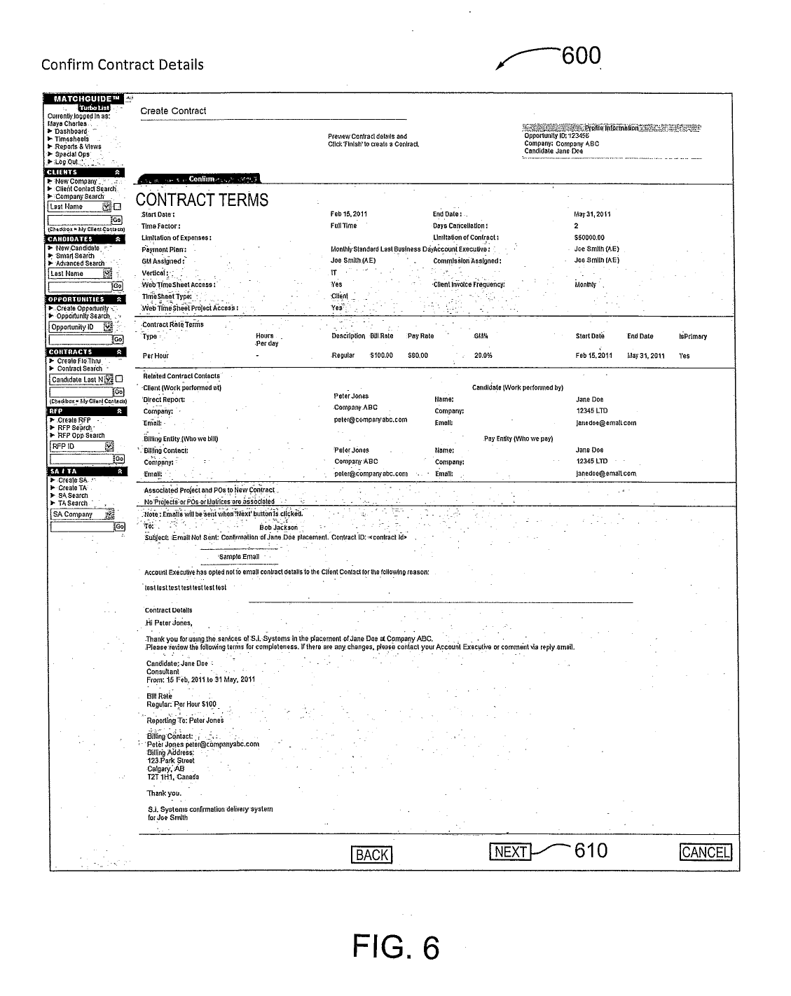

According to embodiment, the Send E-Contract page may be implemented as shown in FIG. 3 and indicated generally by reference 300. According to an embodiment, the Send E-Contract page 300 includes a “Send e-contract to candidate:” radio button 310, which is defaulted to “Yes”. If the user selects the “No” button 310, then page 300 is configured to display a “Reason” field or comment box 312. The user enters the reason as indicated by reference 215 in FIG. 2. If the user selects the “No” button 310 and clicks a “Next” button 314 without inputting anything in the “Reason” field 312, then the system is configured to display an error message, for example, “Please provide the reason why you are not sending the candidate an e-contract for acceptance at this time”. If the user selects the “Yes” button 310 and clicks the “Next” button 314, then the system is configured to display or direct the user to a “Compose Email and Review E-Contract” page (as described in further detail below with reference to FIG. 4 and indicated generally by reference 400). This processing step is indicated by reference 216 in FIG. 2. If the user selects the “No” button 310 and clicks the “Next” button 314, then according to an embodiment, the system is configured to display or direct the user to a “Contract Details Confirm” page (as described in further detail below with reference to FIG. 6 and indicated generally by reference 600). This processing step is indicated by reference 220 in FIG. 2.

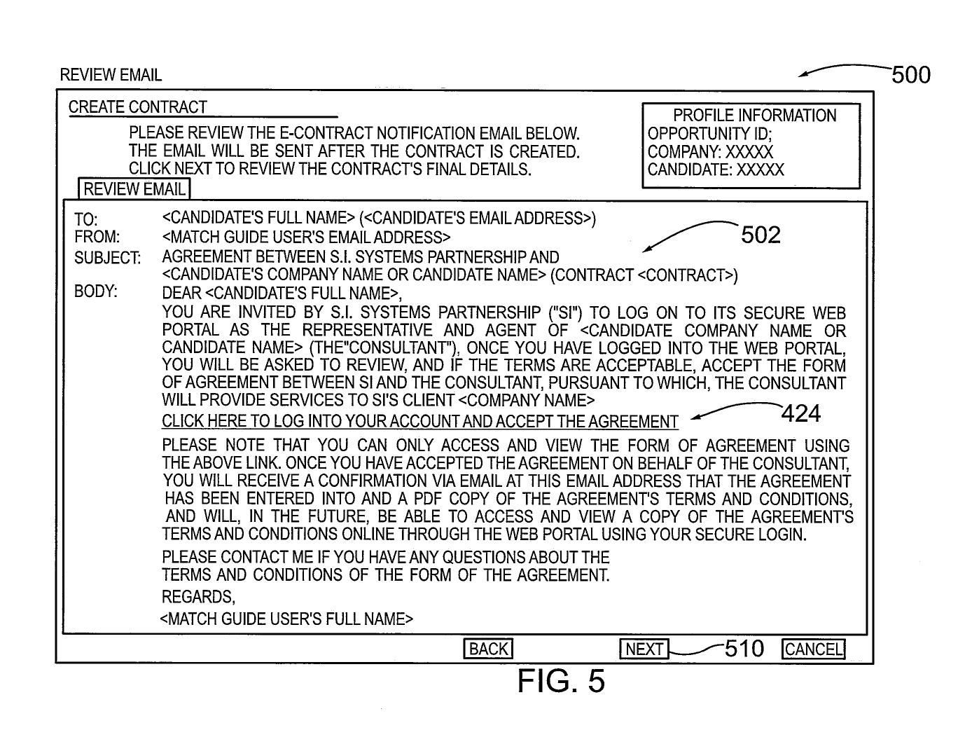

Reference is next made to FIG. 4, which shows the Review E-Contract page 400 according to an embodiment. The Review E-Contract page 400 comprises a Subject field 410 and a Body field 420. According to an embodiment, the Subject field 410 is defaulted to “Agreement between the E-Contracting service provider and a candidate or candidate company”, and is also editable. According to an embodiment, the Body field 420 is defaulted to the following:
Dear <Candidate's Full Name>,
You are invited by S.i. Systems Partnership (“SI”) to log on to its secure web portal as the representative and agent of <Candidate Company Name OR Candidate Name> (the “Consultant”). Once you have logged into the web portal, you will be asked to review, and if the terms are acceptable, accept the form of agreement between SI and the Consultant, pursuant to which, the Consultant will provide services to SI's client <Company Name>.
Click here to log into your account and accept the agreement
Please note that you can only access and view the form of agreement using the above link. Once you have accepted the agreement on behalf of the Consultant, you will receive a confirmation via email at this email address that the agreement has been entered into and a PDF copy of the agreement's terms and conditions, and will, in the future, be able to access and view a copy of the agreement's terms and conditions online through the web portal using your secure login.
Please contact me if you have any questions about the terms and conditions of the form of the agreement.
Regards,
<User's Full Name>
   According to an embodiment, text or content cannot be deleted, but the user may insert text, for example, after the default paragraphs. As shown in FIG. 4, the Review E-Contract page 400 is configured with a PDF icon 422. The system is configured to launch a copy of the associated e-contract in a separate browser window or tab in response to the user clicking the PDF icon 422. According to another aspect, the Body field 420 includes an HTML or other type of active link 424 which is configured to allow a candidate to access a landing page for logging into their account as will be described in more detail below. If the user clicks a “Next” button 426, the system is configured to display or direct the user to a “Review Email” page (as described in further detail below with reference to FIG. 5 and indicated generally by reference 500).

Reference is made to FIG. 5, which shows the Review Email page 500 according to an embodiment of the invention. As described above, the system is configured to display the Review Email page 500 in step 218 as shown in FIG. 2. The Review Email page 500 is configured to allow the user to review an email notification (indicated generally by reference 502) intended to be sent to the candidate. According to an embodiment, the system is configured to the send email notification after the e-contract is created. According to this aspect, the system is configured to display the Contract Details Confirm page 600 in response to the user clicking the Next button 510. An exemplary e-contract is depicted and displayed in the Contract Details Confirm page 600 shown in FIG. 6, and made available for review and/or verification by the user (e.g. Account Executive, client or other administrator). This operation corresponds to step 220 as depicted in FIG. 2. The Contract Details Confirm page 600 is configured with a Next button 610. In response to the user clicking the Next button 610, the system is configured to send the email notification (as described above) to the candidate associated with the e-contract.

Reference is made back to FIG. 2. In response to the Next button 610 (FIG. 6) being clicked in the Contract Details Confirm page 600 (FIG. 6), the system is configured to execute or perform the following functions as depicted in step 222:
an e-contract notification is sent to the candidate's primary email address
a copy of the e-contract is posted to the candidate's web profile (for example, stored in memory (FIG. 1))
time and date information when the e-contract was sent to the candidate is captured/logged in a contract activities field or file
time and date information when the notification email was sent to the candidate is captured/logged in a contract activities field or file
   It will be appreciated that step 222 can include other or additional logging and/or archiving functions.

As shown in FIG. 2, the candidate logs into their email account (indicated by step 230) and opens the notification email received from the system (i.e. the E-Contracting service 110). As indicated by step 232 in FIG. 2, the notification email includes an embedded link 424 (for example, as depicted in FIGS. 4 and 5, and also described above). The candidate clicks the embedded link 424 (FIG. 4) and the system downloads a landing page, e.g. a login page, on the web browser running on the candidate's computer 120 (FIG. 1), or other type of computing device or communication device, such as, a tablet, a mobile phone or handheld communication device, or a plug-in or an application, for example, configured for a tablet or for a mobile phone or smart phone. The login page is configured a secure page requiring the candidate to enter credentials, such as email and password, as indicated by step 234 in FIG. 2. According to an embodiment, the system is configured to log or track the time and date that a candidate logged onto the system and/or attempts to log on.

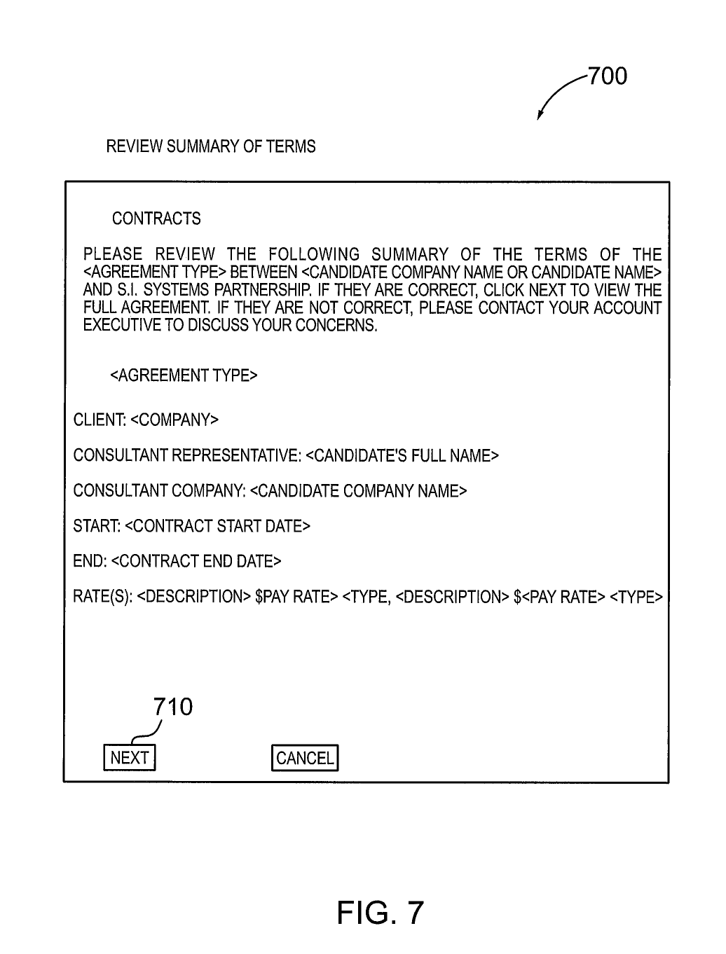

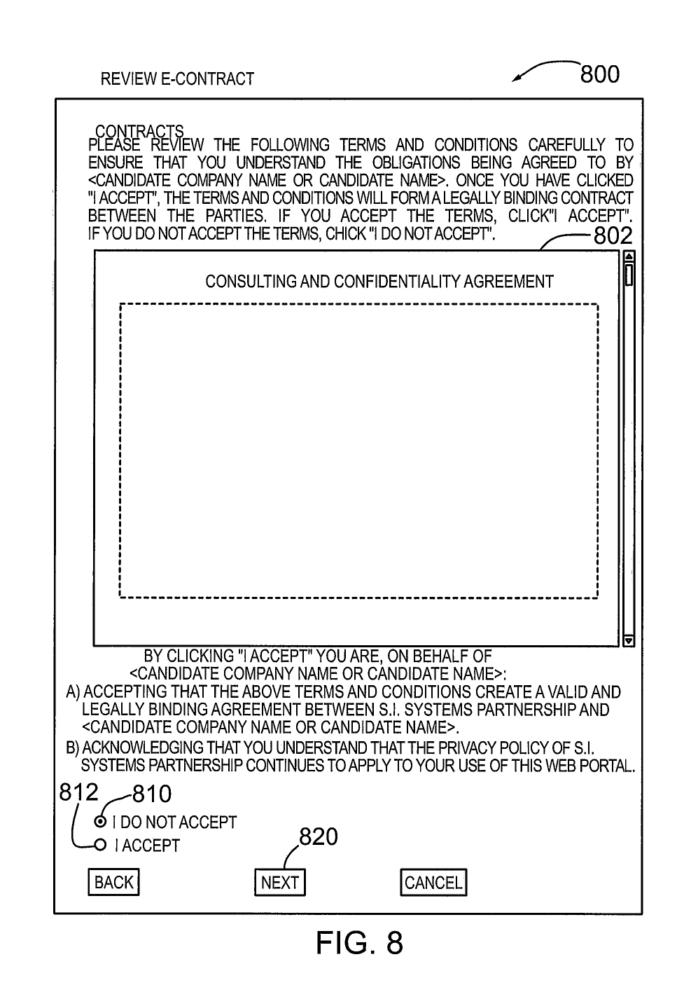

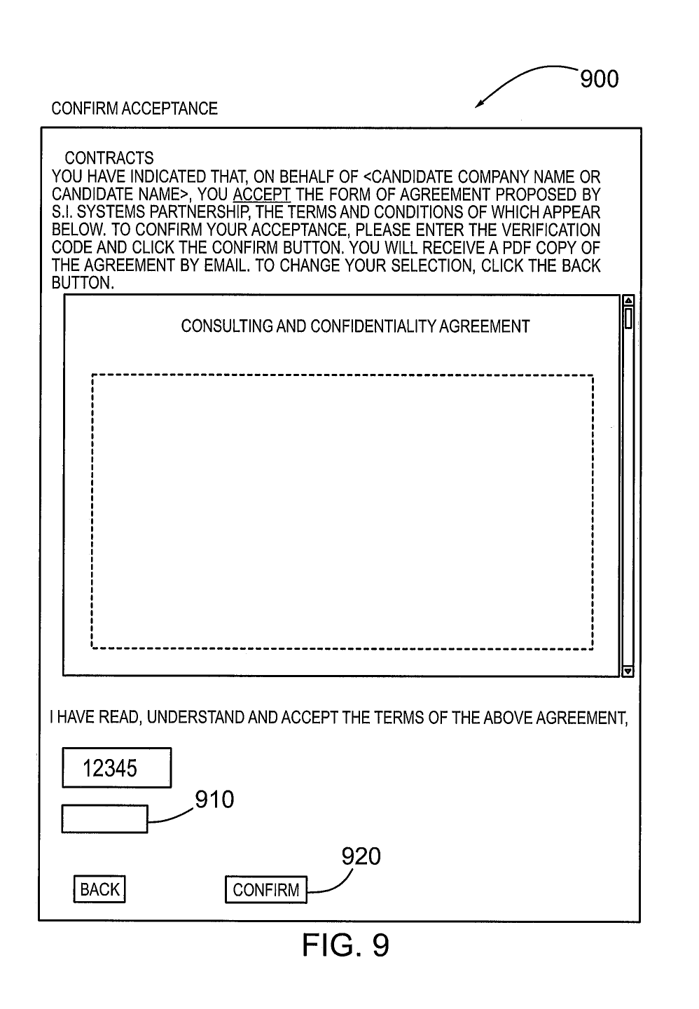

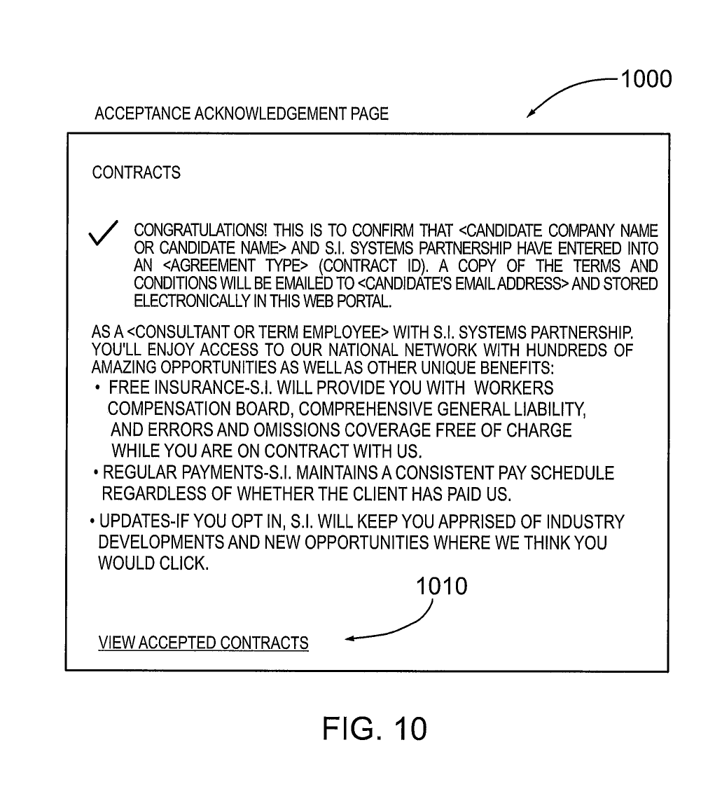

Referring still to FIG. 2 and as indicated by step 236, the system is configured to display a “Review Summary of Terms” page or window after the candidate has been authenticated on the Login page. According to an embodiment, the system is configured to generate a “Review Summary of Terms” page having a form as depicted in FIG. 7 and indicated generally by reference 700. According to an embodiment, the content of the Review Summary page can include the following attributes:
if the contract is with an incorporated candidate, <Candidate Company Name OR Candidate Name> displays the candidate's company name
if the contract with a term employee, <Candidate Company Name OR Candidate Name> displays the candidate's full name.
if the contract is with an incorporated candidate, <agreement type> displays ‘consulting and confidentiality agreement’
if the contract is with a term employee, <agreement type> displays ‘fixed term employment agreement’
if the contract is with a term employee, the “Consultant Company” field is not displayed
if there are multiple rates, they are displayed in the Rate(s) field separated by a comma
   According to one aspect, if the link to the Review Summary of Terms page 700 has expired, the system is configured to display a message directing the candidate to contact their Account Executive. As shown in FIG. 7, the Review Summary of Terms page 700 is configured with a Next button 710. In response to the candidate clicking the Next button 710, the system is configured to display a “Review E-Contract” page or window as shown in FIG. 8 and indicated generally by reference 800. The Review E-Contract page 800 is configured with a scrollable window 802 which displays the contract in an uneditable form, e.g. in PDF, and provides the candidate with the capability to review and/or verify the contract in its fixed electronic form. The Review E-Contract page 800 also includes an “I Do Not Accept” radio button 810 and an “I Accept” radio button 812 and a “Next” button 820. According to an embodiment, the “I Do Not Accept” radio button 810 is the default. According to another aspect, the system is configured to initially disable the radio buttons 810 and 812, and the radio buttons are enabled after the user has scrolled to the bottom of the contract in the scrollable window 802. If the candidate has selected, i.e. clicked, the “I Accept” button 810, then the system is configured to display a “Confirm Acceptance” page such as shown in FIG. 9 and indicated generally by reference 900. As shown in FIG. 9, the Acceptance page 900 is configured with a “CAPTCHA” input field indicated generally by reference 910, and a “Confirm” button indicated generally by reference 920. If the user clicks the Confirm button 920 without inputting a value in the CAPTCHA input field 910, the system is configured to display an error message, such as, “The characters that you entered didn't match the verification code. Please try again” (i.e. step 240 in FIG. 2). If the user clicks Confirm button 920 and the characters that they inputted don't match the CAPTCHA characters, the system is configured to display an error message, for example, “The characters that you entered didn't match the verification code. Please try again” (i.e. step 240 in FIG. 2). If the user doesn't pass the CAPTCHA challenge, the system is configured to display new characters when the page is refreshed. If the inputted characters match the verification code (i.e. step 240 in FIG. 2) and the candidate clicks the “Confirm” button 920, the system is configured to display an “Acceptance Acknowledgement” page, for example, having a form as shown in FIG. 10 and indicated generally by reference 1000, and corresponding to step 242 in FIG. 2. As shown in FIG. 10, the Acceptance Acknowledgement page 1000 includes a “View Accepted Contracts” button as indicated by reference 1010. According to an embodiment, the system is configured to display a “My Accepted Contracts” page showing the contracts for the candidate in response to the View Accepted Contracts button 1010 being clicked.

Reference is made back to FIG. 2. In response to the Confirm button 920 (FIG. 9) being clicked in the Confirm Acceptance page 900 (FIG. 9), the system is configured to execute or perform the following functions as depicted in step 242:
the candidate's acceptance is acknowledged, e.g. the Acceptance Acknowledgement Page 1000 (FIG. 10) is generated and displayed
the acceptance by the candidate is captured or logged/archived
the logged activities associated with the contract are updated with the acceptance state or status
a “consultant verified” status is recorded or logged
the Account Executive is notified of the acceptance
the candidate receives an acknowledgment email
   It will be appreciated that step 222 can include other or additional logging and/or archiving functions.

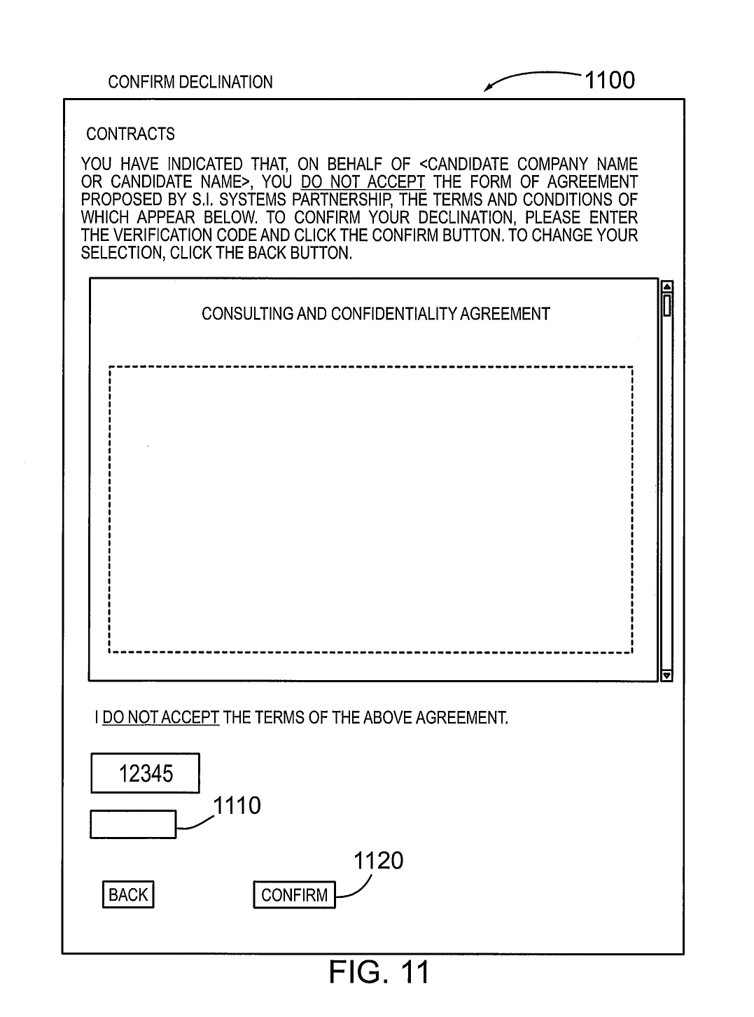

Reference is made to FIG. 2. In step 236, if the candidate elects not to accept the e-contract, i.e. the candidate clicks the “I Do Not Accept” button 810 in the Review E-Contract page 800, then the system is configured to display a “Confirm Declination” page for example as shown in FIG. 11 and indicated generally by reference 1100.

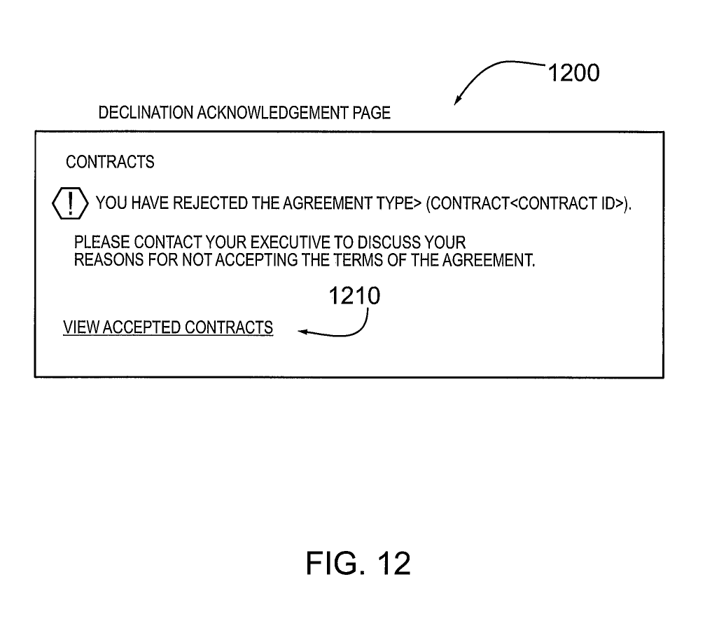

As shown in FIG. 11, the Confirm Declination page 1100 is configured with a “CAPTCHA” input field indicated generally by reference 1110, and a “Confirm” button indicated generally by reference 1120. If the user clicks the Confirm button 1120 without inputting a value in the CAPTCHA input field 1110, the system is configured to display an error message such as, “The characters that you entered didn't match the verification code. Please try again” (i.e. step 252 in FIG. 2). If the user clicks Confirm and the characters that they inputted don't match the CAPTCHA characters, the system is configured to display an error message: “The characters that you entered didn't match the verification code. Please try again” (i.e. step 252 in FIG. 2). If the user doesn't pass the CAPTCHA challenge, the system is configured to display new characters when the page is refreshed. If the inputted characters match the verification code (i.e. step 252 in FIG. 2) and the candidate clicks the “Confirm” button 1120, the system is configured to display a “Declination Acknowledgement” page, for example, having a form as shown in FIG. 12 and indicated generally by reference 1200, and corresponding to step 254 in FIG. 2. As shown in FIG. 12, the Declination Acknowledgement page 1200 includes a “View Accepted Contracts” button as indicated by reference 1210. According to an embodiment, the system is configured to display a “My Accepted Contracts” page showing the previously accepted contracts for the candidate in response to the View Accepted Contracts button 1210 being clicked.

In operation and according to an exemplary embodiment, the verification or acceptance process and system is configured to allow an employment agency (e.g. an account executive) to post an electronic copy of an employment contract for a potential employee (e.g. a consultant) to the a web portal for review and acceptance by the consultant. Once the contract is posted (e.g. available), the system is configured to notify the consultant, for example, by way of an email. The notification includes a link for accessing a web page, and the link is credentialed or secured requiring authentication by the consultant, so that only the consultant can access their contract. The consultant reviews/verifies the contract and the system is configured to receive an acceptance or a declination/refusal by the consultant. If the consultant accepts the contract, the system is configured to store or archive a copy of contract (e.g. a PDF copy) in a database and also log/store the time of the consultant's acceptance. The system is also configured to notify the account executive of the consultant's acceptance. The system is also configured to send the consultant a copy of the accepted contract (e.g. a PDF copy). According to another aspect, the system is configured to allow the consultant to view a copy of the accepted contract in their web portal or page.

It will be appreciated that the system and process according to the present invention can reduce the amount of time required of an account executive to track signatures on contracts, reduce the amount of time required in an accounting or other administrative department verifying the contracts (e.g. formal and/or substantive provisions, such as, duration, renewal, pay rate, signatures, start date, end date, etc.), increase the number of contracts that verified by candidates (e.g. consultants), provide consistent storing/archiving and/or management of executed contracts.

While embodiments according to the present invention are described in the context of employment placement and contracting services, it will be appreciated that the embodiments have wider application to other types of services or applications having or requiring the generation, verification or acceptance of contracts.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A computer-implemented method for confirming acceptance of an employment contract by an employee, said computer-implemented method comprising the steps of:
transmitting a notification to the employee, said notification including a link to access a graphical user interface based login page;
confirming credentials inputted by the employee at said login page;
presenting the user with a graphical user interface based page including an electronic copy of the employment contract;
receiving confirmation from the user at said graphical user interface page;
in response to said confirmation storing a copy of said electronic copy of the contract; and
in response to said confirmation issuing a notification of acceptance of the contract.

2. The computer-implemented method as claimed in claim 1, wherein said step of receiving confirmation comprises receiving an acceptance input from the employee, and prompting the employee to further confirm said acceptance.

3. The computer-implemented method as claimed in claim 2, wherein said further confirmation comprises receiving a verification code inputted by the employee.

4. The computer-implemented method as claimed in claim 1, wherein said notification of acceptance comprises an acceptance acknowledgement page, and said acceptance acknowledgement page being configured with an employee actuated control for viewing one or more accepted contracts associated with the employee.

5. The computer-implemented method as claimed in claim 1, wherein said employee comprises one of a new employee or a new consultant.

6. The computer-implemented method as claimed in claim 1, wherein said employee comprises one of an existing employee or an existing consultant, and the employment contract comprises a renewal employment contract.

7. A system for confirming acceptance of an employment contract by an employee, said system comprising:
a server operatively coupled to one or more computers associated with one or more users;
a component configured for transmitting a notification to the computer associated with the employee;
said notification being configured with a link, and said server being responsive to actuation of said link by the employee for downloading a login page to the computer associated with the employee;
said login page being configured to initiate a login procedure requiring one or more credentials for authenticating the employee;
in response to an authenticated login, said server having a component configured for downloading a review employment contract page to the computer associated with the employee, said review employment contract page being configured with a window responsive to the employee for viewing an electronic copy of the employment contract, and said review employment contract page including an acceptance control responsive to an input from the employee;
said server having a component configured for receiving confirmation of acceptance of the employment contract by the employee and generating a notification of acceptance.

8. The system as claimed in claim 7, further including a mass storage device and wherein said component configured for receiving confirmation of acceptance includes a component configured for storing a copy of said electronic employment contract in said mass storage device, and a component for logging said confirmation of acceptance of the contract by the employee.

9. The system as claimed in claim 8, wherein said notification of acceptance comprises an acceptance acknowledgement page and said server is configured to transmit said acceptance acknowledgement page to the computer associated with the employee, and said acceptance acknowledgement page including a control responsive to actuation by the employee for displaying one or more employment contracts associated with the employee.

10. The system as claimed in claim 7, wherein said employee comprises one of a new employee or a new consultant.

11. The system as claimed in claim 7, wherein said employee comprises one of an existing employee or an existing consultant, and the employment contract comprises a renewal employment contract.

12. The system as claimed in claim 7, wherein one of said users comprises a third party employer, and said system comprises a component configured for notifying said third party employer of said confirmation of acceptance by the employee.

13. A computer program product for performing an acceptance procedure for an electronic employment contract, said computer program product comprising:
a storage medium for storing computer executable instructions, said instructions comprising,
generating a graphical user interface page configured for a browser, said page including a scrollable window for displaying said employment contract in an electronic form and an acceptance control responsive to an input from an employee;
generating an employment contract acceptance state;
storing a copy of said electronic employment contract;
and logging said employment contract acceptance state.

14. The computer program product as claimed in claim 13, wherein said acceptance control comprises a default disabled state, and is configured to switch to an enabled state in response to the entire electronic employment contract being viewed in said scrollable window.

15. The computer program product as claimed in claim 14, further including executable instructions for generating an acceptance acknowledgement page and said acceptance acknowledgement page being configured with a user actuated control for viewing one or more accepted contracts associated with the employee.

16. The computer program product as claimed in claim 13, further including computer executable instructions configured for generating a notification of acceptance comprising an acceptance acknowledgement page and computer executable instructions configured for transmitting said acceptance acknowledgement page to the computer associated with the employee, and said acceptance acknowledgement page including a control responsive to actuation by the employee for displaying one or more employment contracts associated with the employee.

17. The computer program product as claimed in claim 13, wherein said employee comprises one of a new employee or a new consultant.

18. The computer program product as claimed in claim 13, wherein said employee comprises one of an existing employee or an existing consultant, and the employment contract comprises a renewal employment contract.
